(19) United States
(12) Patent Application Publication
(10) Pub. No.: US 2015/0070122 A1
(43) Pub. Date: Mar. 12, 2015

(54) Three Piece Transformer Core

(71) Applicant: Kevin Yang, Lomita, CA (US)

(72) Inventor: Kevin Yang, Lomita, CA (US)

(21) Appl. No.: 14/020,238

(22) Filed: Sep. 6, 2013

(51) Int. Cl. H01F 27/24

(52) U.S. Cl. CPC H01F 27/24
USPC 336/83

(57) ABSTRACT

A three piece transformer core includes a top having a pair of top lateral faces, namely a top left lateral face and a top right lateral face. The top left lateral face has a lower edge bounded at a top lower left face. The top right lateral face has a lower edge bounded at a top lower right face. A core left side section has a core left side section first leg and a core left side section second leg. The core left side section has a left lateral upper face configured to abut the top lower left face of the top. A core right side section has a core right side section first leg and a core right side section second leg. The core right side section has a right lateral upper face configured to abut the top lower right face of the top.

### FIELD OF THE INVENTION

The present invention is in the field of transformers.

### DISCUSSION OF RELATED ART

Transformers are electronic parts that are found in a variety of different electronic products such as televisions and computers. Transformers are also used in power supplies for changing the type of electricity that electronic products might use. Transformers have a variety of different constructions but all have a core with a winding around the core. The core can have a variety of different configurations. Typical transformer cores have a pair of symmetrical sections made of two symmetrical pieces.

Transformer cores transfer energy by inductive coupling between winding circuits. A primary winding and a secondary winding can be wound on a bobbin. Transformers have been used for changing voltage and amperage of electricity for over a hundred years. The patent literature describes a variety of different transformers, such as U.S. Pat. No. 652,027 issued Jun. 19, 1900 to Johannesen. The Johannesen reference describes having core windings around a core, the disclosure of which is incorporated herein by reference. Other transformers are entirely tubular shaped, such as described in Depp U.S. Pat. No. 721,289 entitled Transformer, issued Feb. 24, 1903, the disclosure of which is incorporated herein by reference.

### SUMMARY OF THE INVENTION

A three piece transformer core includes a top having a pair of top lateral faces, namely a top left lateral face and a top right lateral face. The top left lateral face has a lower edge bounded at a top lower left face. The top right lateral face has a lower edge bounded at a top lower right face. A core left side section has a core left side section first leg and a core left side section second leg.

The core left side section has a left lateral upper face configured to abut the top lower left face of the top. A core right side section has a core right side section first leg and a core right side section second leg. The core right side section has a right lateral upper face configured to abut the top lower right face of the top. The core right side section first leg has a right first leg side joining face to abut to a left first leg side joining face of the core left side section first leg. The core right side section second leg has a right second leg side joining face to abut a left second leg side joining face of the core left side section second leg. A bobbin receives the three piece transformer core, and the bobbin further includes electrical contacts formed as legs.

The three piece transformer core optionally also includes a recess formed in a lower surface of the top. The top left lateral face is preferably orthogonal to the top lower left face. The top right lateral face is orthogonal to the top lower right face, wherein the top lower left face is bounded between the top left lateral face and the recess, and wherein the top lower right face is bounded between the top right lateral face and the recess. The core left side section has a left center face formed on a left center post. The core right side section has a right center face formed on a right center post. The left center face does not touch the right center face when the three piece transformer core is assembled. The left center face is located between the left first leg side joining face and the left second leg side joining face. The right center face is located between the right first leg side joining face and the right second leg side joining face. A left first leg upper face formed on core left side section first leg is configured to have flush contact with a left portion of the top lower rear face. A left second leg upper face formed on the core left side section second leg is configured to have flush contact with a left portion of the top lower front face. A right first leg upper face formed on core right side section first leg is configured to have flush contact with a right portion of the top lower rear face. A right second leg upper face formed on the core right side section second leg is configured to have flush contact with a right portion of the top lower front face. The right first leg side joining face, the right second leg side joining face, left first leg side joining face, and left second leg side joining face are preferably rectangular having vertical orientation where the height of the rectangular cross-section is greater than the width of the rectangular cross-section.

### BRIEF DESCRIPTION OF THE DRAWINGS

FIG. 1 is a lower perspective exploded view diagram of the present invention.

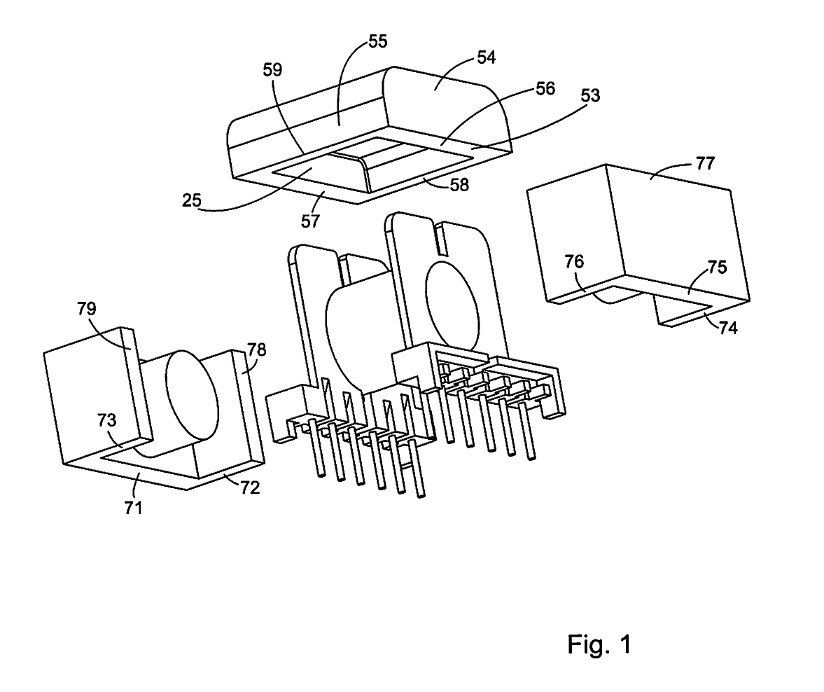

FIG. 2 is an upper perspective exploded view diagram of the present invention.

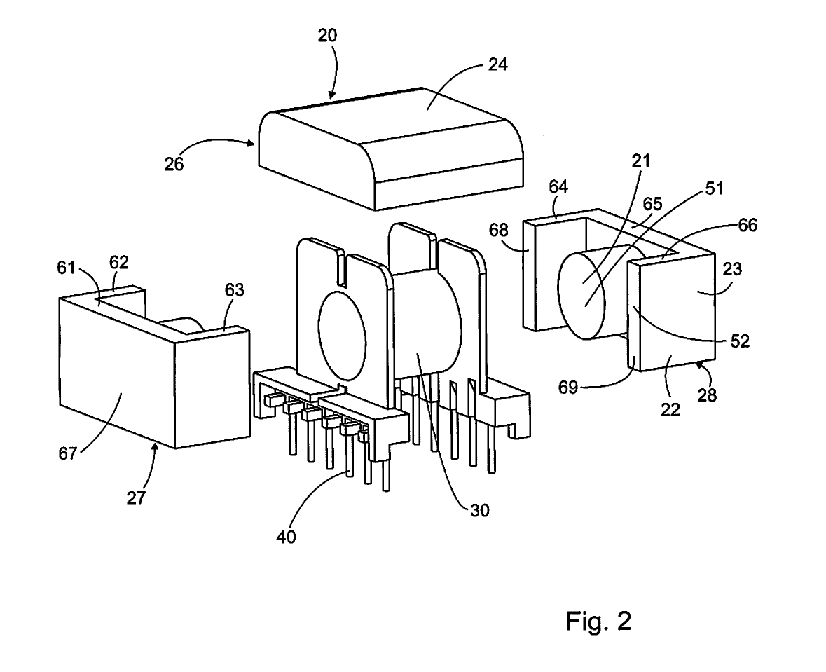

FIG. 3 is an assembled perspective view of the present invention.

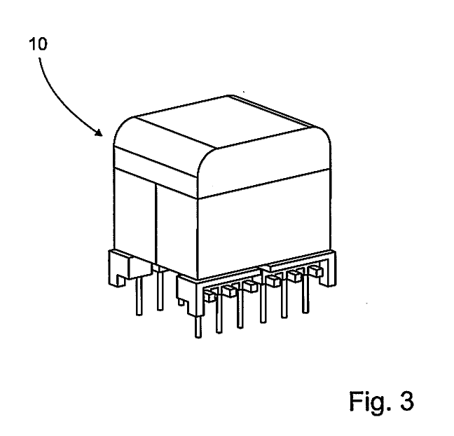

The following call out list of elements can be a useful guide in referencing the element numbers of the drawings.
10 Transformer
20 Core
21 Center Post
22 Leg
23 Side
24 Top
25 Recess
26 Core Top Section
27 Core Left Side Section
28 Core Right Side Section
30 Bobbin
40 Pins
51 Center Face
52 Leg Face
53 Recess Face Vertical Cross-Section
54 Top Lateral Face
55 Top Front Face
56 Top Lower Right Face
57 Top Lower Left Face
58 Top Lower Rear Face
59 Top Lower Front Face
61 Left Lateral Upper Face
62 Left First Leg Upper Face
63 Left Second Leg Upper Face
64 Right First Leg Upper Face
65 Right Lateral Upper Face
66 Right Second Leg Upper Face
67 Left Lateral Side Face
68 Right First Leg Side Joining Face
69 Right Second Leg Side Joining Face
71 Left Lateral Bottom Face
72 Left First Leg Bottom Face
73 Left Second Leg Bottom Face
74 Right First Leg Bottom Face
75 Right Lateral Bottom Face
76 Right Second Leg Bottom Face
77 Right Lateral Side Face
78 Left First Leg Side Joining Face
79 Left Second Leg Side Joining Face

### DETAILED DESCRIPTION OF THE PREFERRED EMBODIMENT

The present invention transformer 10 has a three-piece core 20. The core 20 has a top 24 that connects to a pair of sides 23, namely a core left section 27 and a core right section 28. Each of the sides 23 have a center post 21 that extends from a lateral portion of the side 23. The top 24 aligns to each of the sides 23. The top 24 has a recess face vertical cross-section 53 that defines a periphery of a recess 25 formed on a lower surface of the top 24. The sides have a pair of legs 22 such that there are a total of four legs 22. The core left section 27 has a pair of legs and the core right section 28 also has a pair of legs. The core 25 is formed to fit around a bobbin 30. Pins 40 extend from the bobbin 30. The bobbin 30 and pins 40 can be made according to that shown in the extensive prior art. The core left section and core right section are both shaped with a center face 51 disposed on an inside surface of the center 21. A center face 51 can be circular to match a circular cross-section of the center post. The core left section and core right section additionally have a face of the leg also called the leg face 52.

The core left side section can also be on the right side if a viewer inverts the viewing angle or turns the core upside down. The core left side section can also be on the right side if a viewer inverts the viewing angle or turns the core upside down. The terminology describing the core of the left side section and the core right side section refers to the pair of cores, namely the first core side section and the second core side section as shown in the figures. Similarly, the top and bottom surfaces are describing the orientation of surfaces as shown in the figures. A top surface could be placed on a bottom if the core were mounted upside down. Similarly, a bottom surface could be on the top if the core were mounted upside down. The terminology describing the top or bottom is describing the orientation of surfaces shown in the figures.

The top 24 has a top lateral face 54 at a left and right lateral side of the top 24. The top has a pair of lateral faces 54 that are parallel to each other and oppose each other. The top also has a top front face 55 which is parallel to and opposite orientation of a top rear face. The top 24 is also shaped so that it has a top lower right face 56, top lower left face 57, top lower rear face 58, and top lower front face 59 forming four areas of the recess face vertical cross-section 53. The top lower right face 56 faces downward and the top lower left face 57 also faces downward. The top lower rear face 58 and top lower front face 59 connect the top lower right face 56 to the top lower left face 57. The four areas of the recess face vertical cross-section 53 are preferably parallel to each other. The four areas of the recess face vertical cross-section 53 can form a rectangular or square profile around a recess. The recess face vertical cross-section 53 makes a joining with faces of the side pieces. Generally speaking, the faces are either orthogonal or parallel to each other.

The core left section has various faces including a left lateral upper face 61, a left first leg upper face 62 and a left second leg upper face 63. The left lateral upper face 61 connects to the top lower left face 57 of the top. The left first leg upper face 62 connects to a left half of the top lower rear face 58. Similarly, the left second leg upper face 63 connects to a left half of the top lower front face 59. Preferably, the connection between the top and the side are with a flush exterior surface so that the core could be wrapped in an insulated protective tape during final construction. Making connection means that the members are in contact on a surface or touching on a surface such that the core has generally continuous inductive capability.

The core right section has various faces including a right first leg upper face 64, a right lateral upper face 65 and a right second leg upper face 66. The right first leg upper face 64 is formed on the right leg upper surface so that it makes connection to the right half of the top lower rear face 58. Similarly, the right lateral upper face 65 is configured so that it makes connection with the top lower right face 56. Also, the right second leg upper face 66 makes connection with the right side of the top lower front face 59. The connection being made is preferably one that provides magnetic continuity such that there is no substantial gap between the members.

The core right section and core left section both have a first leg and a second leg. This means that the core right section has a core right section first leg and a core right section second leg. The core left section has a core left section first leg and a core left section second leg. The first leg and the second leg are preferably box shaped having rectangularity and cubic shape. The legs preferably have a top surface that is coplanar to the lateral face that is between the top surface of the legs. The top surface of the first leg is preferably coplanar to the top surface of the second leg. Furthermore, the top surface of the right first leg is preferably coplanar to the top surface of the left first leg. Similarly, the top surface of the right second leg is preferably coplanar to the top surface of the left second leg. Also, the top surface of the lateral portion of the right section called the right lateral upper face 65 is preferably coplanar to the top surface of the lateral portion of the left section called the left lateral upper face 61. Preferably, the left lateral upper face 61, the left first leg upper face 62, the left second leg upper face 63, the right first leg upper face 64, the right lateral upper face 65 and the right second leg upper face 66 are all coplanar and match the profile of the recess face vertical cross-section 53. The top fits on the left and right side sections like a rectangular lid.

The left and right side sections of the core are also joined to each other. The leg faces 52 of each of the left and right side sections are joined to each other meaning that they are touching but not necessarily glued together, although they could be such as by using epoxy or cyanoacrylate. The right first leg side joining face 68 joins to the left first side joining face 78. The right second leg side joining face 69 joins to the left second leg side joining face 79. The leg faces 52 are vertically oriented such that they define a vertically oriented rectangle.

The center face 51 of the left and right sides preferably do not touch each other, but rather have a gap between the surfaces. The bobbin has a circular aperture for receiving the center 21. The leg faces 52 can be molded to be coplanar with the center face 51 when the left and right side sections are originally cast. Subsequently, the center face 51 can be abrasion material removed or cut to a surface that is not coplanar to the leg faces 52.

The left and right side sections of the core having a generally cubical shape may have lateral side faces. For example, the left side may have a left lateral side face 67 and the right side may have a right lateral side face 77. The left side section of the core may further include a left side section bottom face that includes a left lateral bottom face 71, a left first leg bottom face 72, and a left second leg bottom face 73 formed on the left side section. The right side section may have a right side section bottom face that includes a right first leg bottom face 74, a right lateral bottom face 75 and a right second leg bottom face 76. Right side section bottom face and the left side section bottom face are preferably coplanar so that the pair of bottom faces come together to form a rectangular frame around the bobbin. The left second leg bottom face 73 preferably continues to the right second leg bottom face 76. The first left leg bottom face 72 preferably continues to the right first leg bottom face 74.

The right lateral bottom face 75 is orthogonal to the right lateral side face 77. The right lateral side face 77 is orthogonal to the right lateral upper face 65. The right lateral side face 77 is bounded at an upper edge by the right lateral upper face 65, and a right lateral side face 77 is bounded at a lower edge by the right lateral bottom face 75. The right lateral upper face 65 is parallel to the right lateral bottom face 75. The right lateral side face 77 is parallel to the left lateral side face 67. The left lateral side face 67 is orthogonal to the left lateral bottom face 71. The left lateral side face 67 is also orthogonal to the left lateral upper face 61. The left lateral side face 67 is bounded at an upper edge by the left lateral upper face 61, and the left lateral is bounded at a lower edge by the left lateral bottom face 71.

Each of the legs have an outside surface and an inside surface. The leg outside surface and the leg inside surface are both orthogonal to the leg side joining face. For example, a right first leg side joining face 68 is orthogonal to the right first leg outside surface and to the right first leg inside surface. The right first leg side joining face 68 is bounded between the right first leg outside surface and the right first leg inside surface. The right second leg side joining face 69 is orthogonal to the right second leg outside surface and to the right second leg inside surface. The right second leg side joining face 69 is bounded between the right second leg outside surface and the right second leg inside surface. The left first leg side joining face 78 is orthogonal to the left first leg inside surface and to the left first leg outside surface. The left first leg side joining face 78 is bounded between the left first leg inside surface and the left first leg outside surface. Each leg side joining face is bounded at its left and right edges by the leg outside surface and the leg inside surface.

Each leg side joining face is also bounded at its top and bottom edges by the leg upper face and the leg bottom face. The left first leg side joining face 78 is orthogonal to the left first leg upper face 62 and the left first leg bottom face 72. The left first leg side joining face 78 is bounded between the left first leg upper face 62 and the left first leg bottom face 72. The left second leg side joining face 78 is also orthogonal to the left second leg bottom face 73 and the left second leg upper face 63. The left second leg side joining face 78 is bounded between the left second leg bottom face 73 and the left second leg upper face 63. The right first leg side joining face 68 is orthogonal to the right first leg upper face 64 and the right first leg bottom face 74. The right first leg side joining face 68 is also bounded between the right first leg upper face 64 and the right first leg bottom face 74. The right second leg side joining face 69 is orthogonal to the right second leg upper face 66 and the right second leg bottom face 76. The right second leg side joining face 69 is bounded between the right second leg upper face 66 and the right second leg bottom face 76.

The center post preferably is of a circular cross-section while the legs are of rectangular cross-section. The following claims define the scope of the invention.

1. A three piece transformer core comprising:
a. a top having a pair of top lateral faces, namely a top left lateral face and a top right lateral face, wherein the top left lateral face has a lower edge bounded at a top lower left face, wherein the top right lateral face has a lower edge bounded at a top lower right face;
b. a core left side section having a core left side section first leg and a core left side section second leg, wherein the core left side section has a left lateral upper face configured to abut the top lower left face of the top;
c. a core right side section having a core right side section first leg and a core right side section second leg, wherein the core right side section has a right lateral upper face configured to abut the top lower right face of the top; and wherein the core right side section first leg has a right first leg side joining face to abut to a left first leg side joining face of the core left side section first leg, wherein the core right side section second leg has a right second leg side joining face to abut a left second leg side joining face of the core left side section second leg; and
d. a bobbin receiving the three piece transformer core, wherein the bobbin further includes electrical contacts formed as legs.

2. The three piece transformer core of claim 1, further comprising: a recess formed in a lower surface of the top, wherein the top left lateral face is orthogonal to the top lower left face, wherein the top right lateral face is orthogonal to the top lower right face, wherein the top lower left face is bounded between the top left lateral face and the recess, and wherein the top lower right face is bounded between the top right lateral face and the recess.

3. The three piece transformer core of claim 2, wherein the core left side section has a left center face formed on a left center post, wherein the core right side section has a right center face formed on a right center post, wherein the left center face does not touch the right center face when the three piece transformer core is assembled, wherein the left center face is located between the left first leg side joining face and the left second leg side joining face, wherein the right center face is located between the right first leg side joining face and the right second leg side joining face.

4. The three piece transformer core of claim 2, wherein a left first leg upper face formed on core left side section first leg is configured to have flush contact with a left portion of the top lower rear face, wherein a left second leg upper face formed on the core left side section second leg is configured to have flush contact with a left portion of the top lower front face.

5. The three piece transformer core of claim 2, wherein a right first leg upper face formed on core right side section first leg is configured to have flush contact with a right portion of the top lower rear face, wherein a right second leg upper face formed on the core right side section second leg is configured to have flush contact with a right portion of the top lower front face.

6. The three piece transformer core of claim 2, wherein the right first leg side joining face, the right second leg side joining face, left first leg side joining face, and left second leg side joining face are rectangular.

7. The three piece transformer core of claim 1, wherein the core left side section has a left center face formed on a left center post, wherein the core right side section has a right center face formed on a right center post, wherein the left center face does not touch the right center face when the three piece transformer core is assembled, wherein the left center face is located between the left first leg side joining face and the left second leg side joining face, wherein the right center face is located between the right first leg side joining face and the right second leg side joining face.

8. The three piece transformer core of claim 7, wherein a left first leg upper face formed on core left side section first leg is configured to have flush contact with a left portion of the top lower rear face, wherein a left second leg upper face formed on the core left side section second leg is configured to have flush contact with a left portion of the top lower front face.

9. The three piece transformer core of claim 7, wherein a right first leg upper face formed on core right side section first leg is configured to have flush contact with a right portion of the top lower rear face, wherein a right second leg upper face formed on the core right side section second leg is configured to have flush contact with a right portion of the top lower front face.

10. The three piece transformer core of claim 7, wherein the right first leg side joining face, the right second leg side joining face, left first leg side joining face, and left second leg side joining face are rectangular.

11. The three piece transformer core of claim 1, wherein a left first leg upper face formed on core left side section first leg is configured to have flush contact with a left portion of the top lower rear face, wherein a left second leg upper face formed on the core left side section second leg is configured to have flush contact with a left portion of the top lower front face.

12. The three piece transformer core of claim 11, wherein a right first leg upper face formed on core right side section first leg is configured to have flush contact with a right portion of the top lower rear face, wherein a right second leg upper face formed on the core right side section second leg is configured to have flush contact with a right portion of the top lower front face.

13. The three piece transformer core of claim 11, wherein the right first leg side joining face, the right second leg side joining face, left first leg side joining face, and left second leg side joining face are rectangular.

14. The three piece transformer core of claim 1, wherein a right first leg upper face formed on core right side section first leg is configured to have flush contact with a right portion of the top lower rear face, wherein a right second leg upper face formed on the core right side section second leg is configured to have flush contact with a right portion of the top lower front face.

15. The three piece transformer core of claim 1, wherein the right first leg side joining face, the right second leg side joining face, left first leg side joining face, and left second leg side joining face are rectangular.

16. The three piece transformer core of claim 1, further comprising: a recess formed in a lower surface of the top, wherein the top left lateral face is orthogonal to the top lower left face, wherein the top right lateral face is orthogonal to the top lower right face, wherein the top lower left face is bounded between the top left lateral face and the recess, and wherein the top lower right face is bounded between the top right lateral face and the recess, wherein the core left side section has a left center face formed on a left center post, wherein the core right side section has a right center face formed on a right center post, wherein the left center face does not touch the right center face when the three piece transformer core is assembled, wherein the left center face is located between the left first leg side joining face and the left second leg side joining face, wherein the right center face is located between the right first leg side joining face and the right second leg side joining face, wherein a left first leg upper face formed on core left side section first leg is configured to have flush contact with a left portion of the top lower rear face, wherein a left second leg upper face formed on the core left side section second leg is configured to have flush contact with a left portion of the top lower front face, wherein a right first leg upper face formed on core right side section first leg is configured to have flush contact with a right portion of the top lower rear face, wherein a right second leg upper face formed on the core right side section second leg is configured to have flush contact with a right portion of the top lower front face.

17. The three piece transformer core of claim 16, wherein the right first leg side joining face, the right second leg side joining face, left first leg side joining face, and left second leg side joining face are rectangular.
